(19) United States
(12) Patent Application Publication
(10) Pub. No.: US 2007/0277530 A1
(43) Pub. Date: Dec. 6, 2007

(54) Inlet flow conditioner for gas turbine engine fuel nozzle

(76) Inventors: Constantin Alexandru Dinu, Greer, SC (US); Stanley Kevin Widener, Greenville, SC (US); Thomas Edward Johnson, Greer, SC (US)

Correspondence Address: JOHN S. BEULICK (17851), ARMSTRONG TEASDALE LLP, ONE METROPOLITAN SQUARE, SUITE 2600, ST. LOUIS, MO, 63102-2740, US

(21) Appl. No.: 11/443,724

(22) Filed: May 31, 2006

(51) Int. Cl. F02C 1/00

(52) U.S. Cl. 60/772; 60/752

(57) ABSTRACT

A method of operating a gas turbine engine includes providing an inlet flow conditioner (IFC). The IFC has an annular chamber defined therein by at least one wall wherein the wall includes a plurality of perforations extending therethrough. The perforations are spaced in at least two axially-spaced rows that extend circumferentially about the wall. The method also includes channeling a fluid into the IFC and discharging the fluid from the IFC with a substantially uniform flow profile.

### BACKGROUND OF THE INVENTION

This invention relates generally to rotary machines and more particularly, to gas turbine engines and methods of operation.

At least some gas turbine engines ignite a fuel-air mixture in a combustor and generate a combustion gas stream that is channeled to a turbine via a hot gas path. Compressed air is channeled to the combustor by a compressor. Combustor assemblies typically have fuel nozzles that facilitate fuel and air delivery to a combustion region of the combustor. The turbine converts the thermal energy of the combustion gas stream to mechanical energy that rotates a turbine shaft. The output of the turbine may be used to power a machine, for example, an electric generator or a pump.

Some known fuel nozzles include at least one inlet flow conditioner (IFC). Typically, an IFC includes a plurality of perforations and is configured to channel air from the compressor into a portion of the fuel nozzle to facilitate mixing of fuel and air. One known engine channels air into the fuel nozzle to facilitate mitigating air turbulence and to produce a radial and circumferential air flow velocity profile that is substantially uniform within the IFC. Some known IFCs include at least one flow vane that facilitates the generation of a non-uniform radial air flow velocity profile within some portions of the IFC.

### BRIEF DESCRIPTION OF THE INVENTION

In one aspect, a method of operating a gas turbine engine is provided. The method includes providing an inlet flow conditioner (IFC) having an annular chamber defined therein by at least one wall that is formed with a plurality of perforations extending therethrough. The plurality of perforations are spaced in at least two axially-spaced rows that extend substantially circumferentially about the wall. The method also includes channeling a fluid into the IFC and discharging the fluid from the IFC with a substantially uniform flow profile

In another aspect, an inlet flow conditioner (IFC) is provided. The IFC includes an annular chamber at least partially defined therein by a first wall that includes a plurality of perforations extending therethrough. The plurality of perforations are spaced equidistantly circumferentially from each other and are configured to channel a fluid such that a substantially uniform flow profile of the fluid is discharged from the at least one chamber.

In a further aspect, a gas turbine engine is provided. The engine includes a compressor and a combustor in flow communication with the compressor. The combustor includes a fuel nozzle assembly that includes an inlet flow conditioner (IFC). The IFC includes an annular IFC chamber at least partially defined therein by a first wall that includes a plurality of perforations extending therethrough. The plurality of perforations are spaced equidistantly circumferentially from each other and are configured to channel a fluid such that a substantially uniform flow profile discharges from the annular IFC chamber.

### BRIEF DESCRIPTION OF THE DRAWINGS

FIG. 1 is a schematic view of an exemplary gas turbine engine;

FIG. 2 is a cross-sectional schematic view of an exemplary combustor that may be used with the gas turbine engine shown in FIG. 1;

FIG. 3 is a cross-sectional schematic view of an exemplary fuel nozzle assembly that may be used with the combustor shown in FIG. 2;

FIG. 4 is a fragmentary view of an exemplary inlet flow conditioner (IFC) that may be used with the fuel nozzle assembly shown in FIG. 3; and

FIG. 5 is an axial cross-sectional view of the IFC shown in FIG. 4 facing downstream and illustrating a first axial flow stream;

FIG. 6 is an axial cross-sectional view of the IFC shown in FIG. 4 facing downstream and illustrating a second axial flow stream; and

FIG. 7 is an axial cross-sectional view of the IFC shown in FIG. 4 facing downstream and illustrating a third axial flow stream.

### DETAILED DESCRIPTION OF THE INVENTION

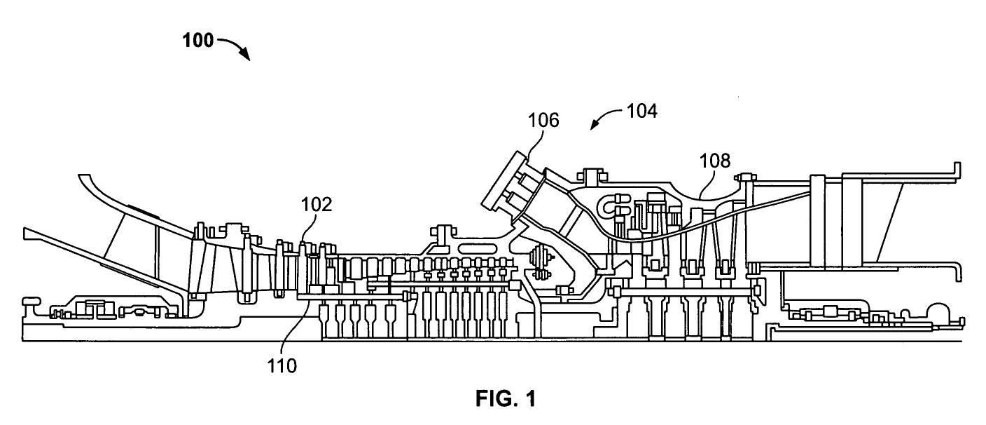

FIG. 1 is a schematic illustration of an exemplary gas turbine engine 100. Engine 100 includes a compressor 102 and a plurality of combustors 104. Combustor 104 includes a fuel nozzle assembly 106. Engine 100 also includes a turbine 108 and a common compressor/turbine shaft 110 (sometimes referred to as rotor 110). In one embodiment, engine 100 is a MS9001H engine, sometimes referred to as a 9H engine, commercially available from General Electric Company, Greenville, S.C.

In operation, air flows through compressor 102 and compressed air is supplied to combustors 104. Specifically, the compressed air is supplied to fuel nozzle assembly 106. Fuel is channeled to a combustion region wherein the fuel is mixed with the air and ignited. Combustion gases are generated and channeled to turbine 108 wherein gas stream thermal energy is converted to mechanical rotational energy. Turbine 108 is rotatably coupled to, and drives, shaft 110.

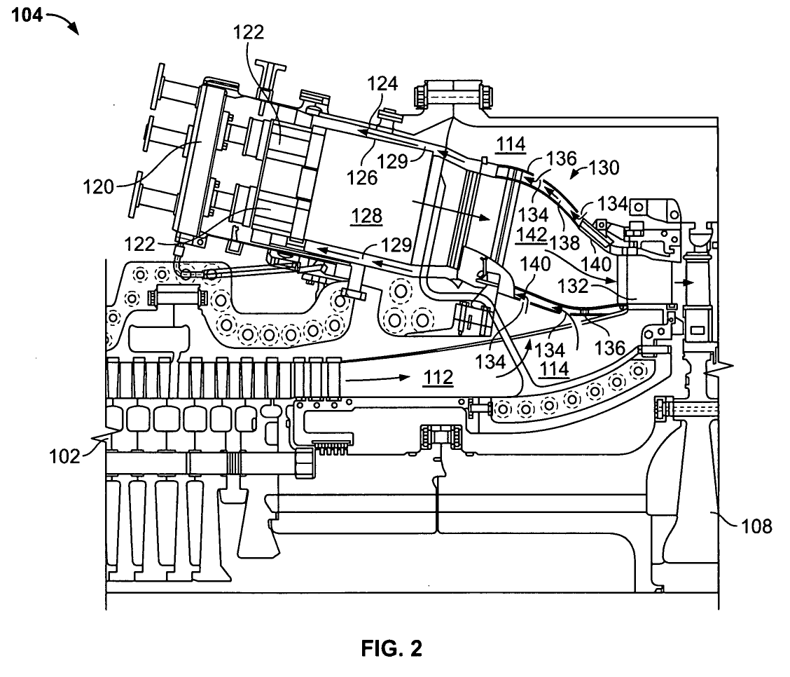

FIG. 2 is a cross-sectional schematic view of combustor 104. Combustor assembly 104 is coupled in flow communication with turbine assembly 108 and with compressor assembly 102. Compressor assembly 102 includes a diffuser 112 and a compressor discharge plenum 114 that are coupled in flow communication to each other.

In the exemplary embodiment, combustor assembly 104 includes a endcover 120 that provides structural support to a plurality of fuel nozzles 122. Endcover 120 is coupled to combustor casing 124 with retention hardware (not shown in FIG. 2). A combustor liner 126 is positioned within and is coupled to casing 124 such that a combustion chamber 128 is defined by liner 126. An annular combustion chamber cooling passage 129 extends between combustor casing 124 and combustor liner 126.

A transition portion or piece 130 is coupled to combustor casing 124 to facilitate channeling combustion gases generated in chamber 128 towards turbine nozzle 132. In the exemplary embodiment, transition piece 130 includes a plurality of openings 134 formed in an outer wall 136. Piece 130 also includes an annular passage 138 defined between an inner wall 140 and outer wall 136. Inner wall 140 defines a guide cavity 142.

In operation, compressor assembly 102 is driven by turbine assembly 108 via shaft 110 (shown in FIG. 1). As compressor assembly 102 rotates, compressed air is discharged into diffuser 112 as the associated arrows illustrate. In the exemplary embodiment, the majority of air discharged from compressor assembly 102 is channeled through compressor discharge plenum 114 towards combustor assembly 104, and a smaller portion of compressed air may be channeled for use in cooling engine 100 components. More specifically, the pressurized compressed air within plenum 114 is channeled into transition piece 130 via outer wall openings 134 and into passage 138. Air is then channeled from transition piece annular passage 138 into combustion chamber cooling passage 129. Air is discharged from passage 129 and is channeled into fuel nozzles 122.

Fuel and air are mixed and ignited within combustion chamber 128. Casing 124 facilitates isolating combustion chamber 128 and its associated combustion processes from the outside environment, for example, surrounding turbine components. Combustion gases generated are channeled from chamber 128 through transition piece guide cavity 142 towards turbine nozzle 132.

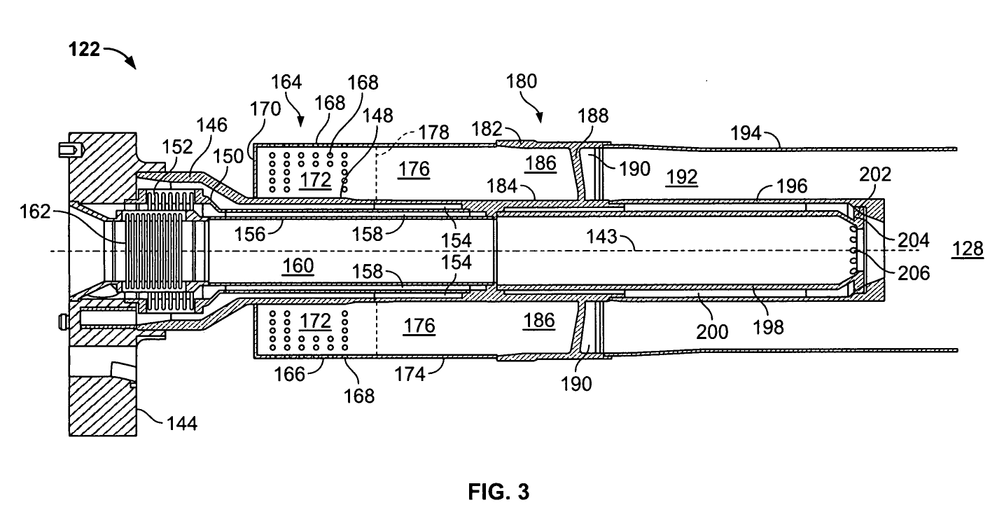

FIG. 3 is a cross-sectional schematic view of fuel nozzle assembly 122. In the exemplary embodiment, an air atomized liquid fuel nozzle (not shown) coupled to assembly 122 to provide dual fuel capability has been omitted for clarity. Assembly 122 has a centerline axis 143 and is coupled to endcover 120 (shown in FIG. 2) via fuel nozzle flange 144.

Fuel nozzle assembly 122 includes a convergent tube 146 that is coupled to flange 144. Tube 146 includes a radially outer surface 148. Assembly 122 also includes a radially inner tube 150 that is coupled to flange 144 via a tube-to-flange bellows 152. Bellows 152 facilitates compensating for varying rates of thermal expansion between tube 150 and flange 144. Tubes 146 and 150 define a substantially annular first premixed fuel supply passage 154. Assembly 122 also includes a substantially annular inner tube 156 that defines a second premixed fuel supply passage 158 in cooperation with radially inner tube 150. Inner tube 156 partially defines a diffusion fuel passage 160 and is coupled to flange 144 via an air tube-to-flange bellows 162 that facilitates compensating for varying rates of thermal expansion between tube 156 and flange 144. Passages 154, 158, and 160 are coupled in flow communication to fuel sources (not shown in FIG. 3). In one embodiment, passage 160 receives the air atomized liquid fuel nozzle therein.

Assembly 122 includes a substantially annular inlet flow conditioner (IFC) 164. IFC 164 includes a radially outer wall 166 that includes a plurality of perforations 168, and an end wall 170 that is positioned on an aft end of IFC 164 and extends between wall 166 and surface 148. Walls 166 and 170 and surface 148 define a substantially annular IFC chamber 172 therein. Chamber 172 is in flow communication with cooling passage 129 (shown in FIG. 2) via perforations 168. Assembly 122 also includes a tubular transition piece 174 that is coupled to wall 166. Transition piece 174 defines a substantially annular transition chamber 176 that is substantially concentrically aligned with respect to chamber 172 and is positioned such that an IFC outlet passage 178 extends between chambers 172 and 176.

Assembly 122 also includes an air swirler assembly or swozzle assembly 180 for use with gaseous fuel injection. Swozzle 180 includes a substantially tubular shroud 182 that is coupled to transition piece 174, and a substantially tubular hub 184 that is coupled to tubes 146, 150, and 156. Shroud 182 and hub 184 define an annular chamber 186 therein wherein a plurality of hollow turning vanes 188 extend between shroud 182 and hub 184. Chamber 186 is coupled in flow communication with chamber 176. Hub 184 defines a plurality of primary turning vane passages (not shown in FIG. 3) that are coupled in flow communication with premixed fuel supply passage 154. A plurality of premixed gas injection ports (not shown in FIG. 3) are defined within hollow turning vanes 188. Similarly, hub 184 defines a plurality of secondary turning vane passages (not shown in FIG. 3) that are coupled in flow communication with premixed fuel supply passage 158 and a plurality of secondary gas injection ports (not shown in FIG. 3) that are defined within turning vanes 188. Inlet chamber 186, and the primary and secondary gas injection ports, are coupled in flow communication with an outlet chamber 190.

Assembly 122 further includes a substantially annular fuel-air mixing passage 192 that is defined by a tubular shroud extension 194 and a tubular hub extension 196. Passage 192 is coupled in flow communication with chamber 190 and extensions 194 and 196 are each coupled to shroud 182 and hub 184, respectively.

A tubular diffusion flame nozzle assembly 198 is coupled to hub 184 and partially defines annular diffusion fuel passage 160. Assembly 198 also defines an annular air passage 200 in cooperation with hub extension 196. Assembly 122 also includes a slotted gas tip 202 that is coupled to hub extension 196 and assembly 198, and that includes a plurality of gas injectors 204 and air injectors 206. Tip 202 is coupled in flow communication with, and facilitates fuel and air mixing in, combustion chamber 128.

In operation, fuel nozzle assembly 122 receives compressed air from cooling passage 129 (shown in FIG. 2) via a plenum (not shown in FIG. 3) surrounding assembly 122. Most of the air used for combustion enters assembly 122 via IFC 164 and is channeled to premixing components. Specifically, air enters IFC 164 via perforations 168 and mixes within chamber 172 and air exits IFC 164 via passage 178 and enters swozzle inlet chamber 186 via transition piece chamber 176. A portion of high pressure air entering passage 129 is also channeled into an air-atomized liquid fuel cartridge (not shown in FIG. 3) inserted within diffusion fuel passage 160.

Fuel nozzle assembly 122 receives fuel from a fuel source (not shown in FIG. 3) via premixed fuel supply passage 154 and 158. Fuel is channeled from premixed fuel supply passage 154 to the plurality of primary gas injection ports defined within turning vanes 188. Similarly, fuel is channeled from premixed fuel supply passage 158 to the plurality of secondary gas injection ports defined within turning vanes 188.

Air channeled into swozzle inlet chamber 186 from transition piece chamber 176 is swirled via turning vanes 188 and is mixed with fuel, and the fuel/air mixture is channeled to swozzle outlet chamber 190 for further mixing. The fuel and air mixture is then channeled to mixing passage 192 and discharged from assembly 122 into combustion chamber 128. In addition, diffusion fuel channeled through diffusion fuel passage 160 is discharged through gas injectors 204 into combustion chamber 128 wherein it mixes and combusts with air discharged from air injectors 206.

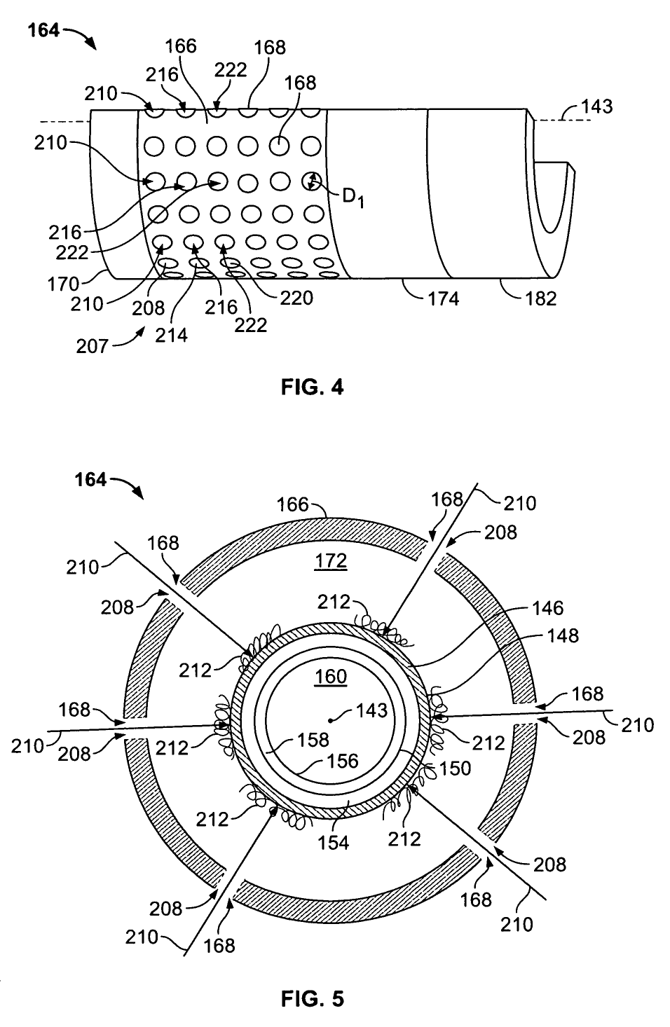

FIG. 4 is a fragmentary view of IFC 164. Centerline axis 143, transition piece 174 and swozzle shroud 182 are illustrated for perspective. FIG. 5 is an axial cross-sectional view of exemplary IFC 164 facing downstream and illustrating a first axial flow stream 212. Centerline axis 143, diffusion fuel passage 160, tube 156, premixed fuel supply passage 158, radially inner tube 150, premixed fuel supply passage 154, convergent tube 146, and convergent tube radially outer surface 148 are illustrated for perspective. Only six circumferentially spaced perforations 168 are illustrated in FIG. 5. Alternatively, IFC 164 may include any number of perforations 168. IFC 164 includes radially outer wall 166 that defines plurality of substantially circular perforations 168. In the exemplary embodiment, IFC 164 includes six axially spaced rows 207 of perforations 168. For example, in FIG. 4, first, second and third circumferential perforation rows 208, 214 and 220, respectively, are identified. Alternatively, IFC 164 may include any number of axially-spaced rows 207 of perforations 168.

In the exemplary embodiment, perforations 168 are each formed substantially identical in diameter D₁ and the axially-spaced rows 207 are oriented such that six perforations are substantially axially aligned. Moreover, in the exemplary embodiment, perforations 168 are spaced substantially equally circumferentially and axially. The exemplary orientation of perforations 168 facilitates mitigating a pressure drop across IFC 164 that subsequently facilitates improving engine efficiency. Alternatively, IFC 164 may include any number of perforations 168 arranged in any orientation that enables IFC 164 to function as described herein.

IFC 164 may also include an end wall 170 that is positioned on an aft end of IFC 164 extending between wall 166 and surface 148. IFC 164 may be coupled to tube 146 such that walls 166 and 170, and surface 148 define an annular IFC chamber 172 therein. Chamber 172 is coupled in flow communication with combustion chamber cooling passage 129 (shown in FIG. 2) via perforations 168.

In operation, compressed air from passage 129 flows around IFC 164. Perforations 168 facilitate increasing the backpressure around an outer periphery of IFC 164 by restricting air flow into IFC 164. The increased backpressure facilitates substantially equalizing air flow through perforations 168. For example, air flows through perforations 208 and enters chamber 172 in a plurality of radial air streams 210 (only three illustrated in FIG. 4 and only six illustrated in FIG. 5). A substantial portion of each air stream 210 impinges against surface 148 and change direction to substantially fill that portion of chamber 172 defined between row 208 and end cap 170. As such, static pressure is generated within that portion of chamber 172. Another portion of radial air streams 210 that impinge surface 148 change direction and are channeled towards transition piece 174. Radial air streams 210 form a boundary layer of air over a portion of surface 148 such that a plurality of axial air streams 212 (only six illustrated in FIG. 5) are formed and are defined with a first radial and circumferential velocity profile within chamber 172. Axial air streams 212 that are formed tend to flow substantially parallel to the row of perforations 208 that admitted the first radial air streams 210. A lesser portion of air streams 212 flow into that portion of chamber 172 defined between perforations 208. Air streams 212 tend to expand in the radial and circumferential directions as they travel towards transition piece 174. As such, the radial and circumferential velocity profile of air streams 212 is substantially non-uniform.

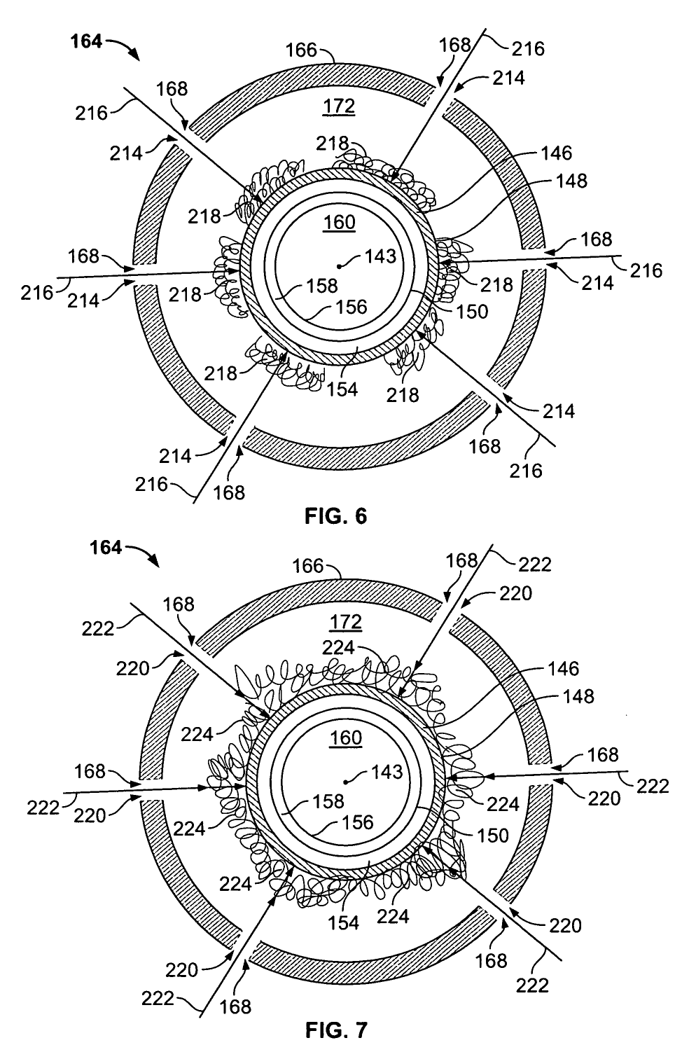

FIG. 6 is an axial cross-sectional view of IFC 164 facing downstream, and illustrating a second axial flow stream 218. Centerline axis 143, diffusion fuel passage 160, inner tube 156, premixed fuel supply passage 158, radially inner tube 150, premixed fuel supply passage 154, convergent tube 146, and convergent tube radially outer surface 148 are illustrated for perspective. For clarity, only six perforations 168 are illustrated in FIG. 6. Air flows through second row 214 and enters chamber 172 in a plurality of radial air streams 216 (only three are illustrated in FIG. 4 and only six are illustrated in FIG. 6). A substantial portion of air streams 216 impinges against surface 148 and air streams 212 such that a plurality of second axial air streams 218 are formed that have a second radial and circumferential velocity profile within chamber 172. Axial air streams 218 tend to form such that circumferential regions of chamber 172 defined between axial perforations 208 and 214 fill in with flowing air. This action thereby decreases the difference in mass flow between the portion of air streams 218 directly under perforations 168 and the portion of air streams 218 between circumferentially adjacent perforations 168. Air streams 218 flowing towards transition piece 174 tend to expand in the radial and circumferential directions. Therefore, in general, the radial and circumferential velocity profile of air streams 218 is more uniform than the velocity profile of air streams 212.

FIG. 7 is an axial cross-sectional view of IFC 164 facing downstream and illustrating a third axial flow stream 224. Centerline axis 143, diffusion fuel passage 160, inner tube 156, premixed fuel supply passage 158, radially inner tube 150, premixed fuel supply passage 154, convergent tube 146, and convergent tube radially outer surface 148 are illustrated for perspective. For clarity, only six perforations 168 are illustrated in FIG. 7. Air flows through third row 220 and enters chamber 172 in a plurality of radial air streams 222 (only three are illustrated in FIG. 4 and only six are illustrated in FIG. 7). A first portion of each air stream 222 impinges against surface 148 and a second portion of each air stream 222 impinges air streams 218 such that a plurality of third axial air streams 224 are formed that have a third radial and circumferential velocity profile within chamber 172. Axial air streams 224 tend to form such that circumferential regions of chamber 172 defined between perforations 208, 214 and 220 fill in with flowing air. This action thereby further decreases the difference in mass flow between the portion of air streams 224 directly under perforations 168 and the portion of air streams 224 between circumferentially adjacent perforations 168. Air streams 224 flowing towards transition piece 174 tend to expand in the radial and circumferential directions. In general, the radial and circumferential velocity profile of air streams 224 is more uniform than the velocity profile of air streams 218.

The iterative process of subsequent radial streams impinging on the composite axial streams induces a flow velocity profile into the air flowing within chamber 172 across IFC outlet passage 178 (shown in FIG. 3) into transition piece 174 that is substantially constant in the radial direction across passage 178. The substantially uniform velocity profile of air facilitates reducing pockets of rich, or excess, air within fuel nozzle 122 and combustion chamber 142 that subsequently facilitates a reduction in formation of undesirable combustion byproducts, such as NOₓ. Similarly, the substantially uniform velocity profile of air facilitates reducing pockets of lean air within fuel nozzle 122 and combustion chamber 142 thereby facilitating increased flame stability.

The methods and apparatus for assembling and operating a combustor described herein facilitates operation of a gas turbine engine. More specifically, the inlet flow conditioner facilitates a more uniform air flow velocity profile being induced within the fuel nozzle assembly. Such air flow profile facilitates efficiency of combustion and a reduction in undesirable combustion by-products. Moreover, the inlet flow conditioner facilitates reducing capital and maintenance costs, as well as increasing operational reliability.

Exemplary embodiments of inlet flow conditioners as associated with gas turbine engines are described above in detail. The methods, apparatus and systems are not limited to the specific embodiments described herein nor to the specific illustrated inlet flow conditioner.

While the invention has been described in terms of various specific embodiments, those skilled in the art will recognize that the invention can be practiced with modification within the spirit and scope of the claims.

What is claimed is:

1. A method of operating a gas turbine engine, said method comprising:
providing an inlet flow conditioner (IFC) having an annular chamber defined therein by at least one wall that includes a plurality of perforations extending therethrough, wherein the plurality of perforations are circumferentially spaced in at least two axially-spaced rows that extend substantially circumferentially about the wall;
channeling fluid into the IFC; and
discharging fluid from the IFC with a substantially uniform flow profile.

2. A method in accordance with claim 1 wherein channeling fluid into the IFC comprises channeling at least a portion of fluid through the plurality of perforations.

3. A method in accordance with claim 2 wherein channeling at least a portion of fluid through the plurality of perforations comprises impinging fluid against a cylindrical surface positioned within the IFC.

4. A method in accordance with claim 3 wherein impinging fluid against a cylindrical surface positioned within the IFC comprises:
channeling a first portion of fluid through at least some of a first circumferential row of perforations such that a first stream of fluid having a first fluid velocity profile is formed over at least a portion of the cylindrical surface; and
channeling a second portion of fluid through at least some of a second circumferential row of perforations such that at least a portion of the second portion of the fluid intersects the first stream of the fluid and forms a second stream of fluid having a second fluid velocity profile, wherein the second circumferential row of perforations is downstream from the first circumferential row of perforations.

5. A method in accordance with claim 4 further comprising:
impinging at least a portion of the second portion of fluid on at least a portion of the cylindrical surface; and
channeling at least a portion of the first portion and at least a portion of the second portion of fluid into an annular chamber.

6. A method in accordance with claim 4 wherein impinging fluid against a cylindrical surface further comprises channeling a third portion of fluid through at least some of a third circumferential row of perforations such that at least a portion of the third portion of fluid intersects the second stream of the fluid and forms a third stream of fluid having a third fluid velocity profile, wherein the third row of circumferential perforations is downstream from the second circumferential row of perforations.

7. A method in accordance with claim 6 further comprising:
impinging at least a portion of the third portion of fluid on at least a portion of the cylindrical surface; and
channeling at least a portion of the first portion of fluid, at least a portion of the second portion of fluid and at least a portion of the third portion of fluid into an annular chamber.

8. An inlet flow conditioner (IFC), said IFC comprising an annular chamber at least partially defined therein by a first wall, said first wall comprising a plurality of perforations extending therethrough, said plurality of perforations spaced substantially equidistant circumferentially and are configured to discharge a fluid having a substantially uniform flow profile from said IFC chamber.

9. An IFC in accordance with claim 8 wherein said first wall comprises a substantially cylindrical outer wall, said IFC further comprises:
a substantially cylindrical inner wall; and
a substantially annular axial end wall extending between said inner and outer walls.

10. An IFC in accordance with claim 9 wherein said inner wall, said outer wall, and said end wall define said IFC chamber.

11. An IFC in accordance with claim 10 wherein at least a portion of said inner wall and at least a portion of said outer wall define an annular passage that is axially opposite said end wall, said passage facilitates coupling said IFC chamber in flow communication with a swozzle assembly that is axially downstream from said IFC chamber.

12. An IFC in accordance with claim 8 wherein at least a portion of said plurality of perforations forms a substantially axially linear configuration at least partially defining at least one circumferential row.

13. An IFC in accordance with claim 8 wherein said IFC is coupled in flow communication with a fluid source.

14. An IFC in accordance with claim 13 wherein the fluid source is a gas turbine compressor.

15. A gas turbine engine, said engine comprising:
a compressor; and
a combustor in flow communication with said compressor, said combustor comprising a fuel nozzle assembly, said fuel nozzle assembly comprising at least one swozzle assembly and at least one inlet flow conditioner (IFC), said IFC comprising an annular IFC chamber at least partially defined therein by a first wall, said first wall comprising a plurality of perforations extending therethrough, said plurality of perforations spaced substantially equidistant circumferentially and are configured to discharge a fluid having a substantially uniform flow profile from said IFC chamber.

16. A gas turbine engine in accordance with claim 15 wherein said first wall comprises a substantially cylindrical outer wall, said IFC further comprises:
a substantially cylindrical inner wall; and
a substantially annular axial end wall extending between said inner and outer walls.

17. A gas turbine engine in accordance with claim 16 wherein said inner wall, said outer wall, and said end wall define said IFC chamber.

18. A gas turbine engine in accordance with claim 17 wherein at least a portion of said inner wall and at least a portion of said outer wall define an annular passage that is axially opposite said end wall, said passage facilitates coupling said IFC chamber in flow communication with said swozzle assembly that is axially downstream from said IFC chamber.

19. A gas turbine engine in accordance with claim 18 wherein said combustor defines at least one combustion chamber, wherein said combustion chamber is coupled in flow communication with said fuel nozzle assembly, said IFC cooperates with said swozzle assembly to discharge fluid having a substantially uniform flow profile from said fuel nozzle assembly into said combustion chamber.

20. A gas turbine engine in accordance with claim 15 wherein at least a portion of said plurality of perforations forms a substantially axially linear configuration at least partially defining at least one circumferential row.
